(19) United States
(12) Patent Application Publication
(10) Pub. No.: US 2007/0122209 A1
(43) Pub. Date: May 31, 2007

(54) Hybrid type image forming apparatus

(75) Inventors: Hisao Okada, Suwon-si (KR); Won Choe, Yongin-si (KR); Hyun-Wook Bae, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/517,507

(22) Filed: Sep. 8, 2006

(30) Foreign Application Priority Data
Nov. 28, 2005 (KR) 2005-114051

(51) Int. Cl. G03G 15/08

(52) U.S. Cl. 399/282

(57) ABSTRACT

A hybrid type image forming apparatus is provided. The apparatus uses a developer that contains a mixture of a toner and a carrier, and includes a photosensitive body and a development unit. An electrostatic latent image is formed on the photosensitive body. The development unit includes a magnetic roller and a developing roller. The magnetic roller forms a magnetic brush containing the toner and the carrier on the outer periphery of the magnetic roller, and the developing roller is installed such that the developing roller does not contact the magnetic roller and the photosensitive body to develop the electrostatic latent image using the toner supplied from the magnetic brush. A resistivity of the developer is no greater than 10⁹ Ωcm.

### CROSS-REFERENCE TO RELATED PATENT APPLICATION

This application claims the benefit under 35 U.S.C. §119(a) of Korean Patent Application No. 10-2005-0114051, filed on Nov. 28, 2005, in the Korean Intellectual Property Office, the entire disclosure of which is hereby incorporated by reference.

### BACKGROUND OF THE INVENTION

1. Field of the Invention

The present invention relates to an electrophotographic image forming apparatus. More particularly, the present invention relates to an image forming apparatus employing a hybrid development method.

2. Description of the Related Art

A development method of image forming apparatuses such as copying machines, printers, facsimiles, and multifunctional peripherals includes a variety of additional methods such as a dual component development method, a mono component development method, and a hybrid development method. The dual component development method uses a toner and a magnetic carrier. The mono component development method uses an insulation toner or a conductive toner. The hybrid development method comprises a non-magnetic toner charged by rubbing the non-magnetic toner against a magnetic carrier to allow only the charged toner to be attached on a developing roller and supplying the charged toner to an electrostatic latent image, thereby developing the electrostatic latent image.

Advantages of the dual component development method include excellent charging characteristics of the toner, long life, and a uniform beta image. Alternatively, the dual component development method has disadvantages that include a large apparatus size, a complicated structure, scattering of the toner, and attachment of the carrier onto the latent image.

The advantages of the mono component development method include its compact structure, excellent dot reproducibility and a background fog. The background fog means that the toner is attached on the background portion of a photosensitive body. The background fog occurs because much of toner charged at an opposite polarity exists on a developing roller. The dual component development method charges toner by mixing the toner with carrier and agitating the mixture. This reduces the possibility of generating the toner of the opposite polarity. However, the mono component development method has toner attached on a developing roller and then charges the toner by rubbing a regulating blade against the toner, so that the toner is not sufficiently charged and thus there is a high possibility that the toner of the opposite polarity is generated. Examination of an amount of charge of the toner using an E-Spart Analyzer, which is a device for measuring distribution of an amount of charge of particle by Hosokawa Micron Co., Ltd., demonstrates the existence of 10%-25% of toner with the opposite polarity.

The hybrid development method charges toner by mixing the toner with a carrier and agitating the mixture. A magnetic brush containing the carrier and the toner is formed on a magnetic roller. A bias moving the toner from the magnetic brush to the developing roller is applied between the magnetic roller and the developing roller. Only toner with an appropriate charged polarity caused by the bias is moved from the magnetic brush to the developing roller. Toner charged to an opposite polarity does not easily move to the developing roller. Therefore, this prevents the contamination of the background portion. Only the toner is supplied to a development region where a photosensitive body faces the developing roller. Therefore, it is possible to reduce attachment of the carrier onto a latent image or toner scattering. That is, the hybrid development method is a development method that takes advantage of the dual component development method and the mono component development method. However, the hybrid development method has a problem of a development ghost. The toner on the developing roller moves to the photosensitive body while passing through the development region where the photosensitive body faces the developing roller. After that, a sufficient amount of toner should be supplied to the developing roller so that a uniform toner layer may be formed on the developing roller. When the toner layer is not uniform, an afterimage of a previous development appears by a rotational period of the developing roller on an image developed on the photosensitive body, which is called a development ghost.

Accordingly, there is a need for an improved system and method for providing a hybrid type image forming apparatus capable of preventing a development ghost.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a hybrid type image forming apparatus capable of preventing a development ghost.

Exemplary embodiments of the present invention also provide a hybrid type image forming apparatus capable of preventing contamination of a background portion.

Exemplary embodiments of the present invention also provide a hybrid type multi-color image forming apparatus capable of achieving a high quality and stable development by adopting a tri-level exposure method.

According to an aspect of an exemplary embodiment of the present invention, a hybrid type image forming apparatus is provided that uses a developer that contains a mixture of a toner and a carrier. An electrostatic latent image is formed on a photosensitive body. The apparatus also comprises a development unit with a magnetic roller forming a magnetic brush containing the toner and the carrier on the outer periphery of the magnetic roller. A developing roller is installed to prevent the developing roller from contacting the magnetic roller and the photosensitive body to develop the electrostatic latent image using the toner supplied from the magnetic brush, wherein the resistivity of the developer is no greater than 10⁹ Ωcm.

The resistivity of the carrier may be no greater than 10⁸ Ωcm.

The magnetic roller may include a rotating sleeve and a magnetic core with a plurality of magnetic poles forming the magnetic brush and arranged inside the sleeve. The plurality of magnetic poles include a pair of magnetic poles with the same polarity and facing a supply region where the magnetic roller faces the developing roller. In the supply region, movement directions of the surfaces of the sleeve and the developing roller may be similar.

The developing unit may further include a collision member installed in the supply region and colliding with the magnetic brush.

The magnetic roller may include a rotating sleeve and a magnetic core with a plurality of magnetic poles forming the magnetic brush and arranged inside the sleeve to rotate. The magnetic core may rotate in a direction opposite to a rotational direction of the sleeve. In a supply region where the developing roller faces the magnetic roller, movement directions of the surfaces of the sleeve and the developing roller may be similar.

A bias generating a pulsating electric field may be applied between the magnetic roller and the developing roller.

The hybrid type image forming apparatus may further include a charger, an exposer and a plurality of development units. The charger charges the photosensitive body, the exposer scans light on the photosensitive body and the plurality of development units contain toners of different colors, thereby printing a color image.

The hybrid type image forming apparatus may also include a first image forming unit, a charger, an exposer and two developing units. The first image forming unit comprises the photosensitive body, the charger charges the photosensitive body, the exposer exposes the photosensitive body in a tri-level exposure method and the two developing units containing toner of a first color and toner of a second color, respectively. The hybrid type image forming apparatus also includes a second image forming unit, a charger, an exposer, two developing units and an intermediate transfer body. The second image forming unit comprises the photosensitive body, the charger charges the photosensitive body, the exposer exposes the photosensitive body in a tri-level exposure method, and two developing units contain toner of a third color and toner of a fourth color, respectively and the intermediate transfer body transfers a toner image from the first and second image forming units, thereby printing a color image in a single-pass type.

The hybrid type image forming apparatus may include a charger, an exposer and four developing units. The charger charges the photosensitive body and the exposer exposes the photosensitive body in a tri-level exposure method. The four developing units contain toners of a first color, a second color, a third color, and a fourth color, respectively, thereby printing a color image in a two-pass type.

According to another aspect of an exemplary embodiment of the present invention, a hybrid type image forming apparatus using a developer that contains a mixture of a toner and a carrier is provided. According to an exemplary implementation, an electrostatic latent image is formed on a photosensitive body. A magnetic roller forms a magnetic brush including the toner and the carrier on the outer periphery of the magnetic roller. A developing roller is installed to prevent the developing roller from contacting the magnetic roller and the photosensitive body to develop the electrostatic latent image using the toner supplied from the magnetic brush. The magnetic roller includes a rotating sleeve, and a magnetic core with a plurality of magnetic poles forming the magnetic brush and arranged inside the sleeve. Also, the plurality of magnetic poles include a pair of magnetic poles with the same polarity and facing a supply region where the magnetic roller faces the developing roller.

In the supply region, movement directions of the surfaces of the sleeve and the developing roller may be similar. The image forming apparatus may further include a wire installed in the supply region and colliding with the magnetic brush. The resistivity of the carrier may be no greater than 10⁸ Ωcm. A bias generating a pulsating electric field may be applied between the magnetic roller and the developing roller.

Other objects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a view of an image forming apparatus according to an exemplary embodiment of the present invention;

FIG. 2 is a graph illustrating the resistivity of a developer versus efficiency of forming a toner layer on a developing roller according to an exemplary embodiment of the present invention;

FIG. 3 is a view illustrating an example of an apparatus for measuring the resistance of a developer according to an exemplary embodiment of the present invention;

FIG. 4 is a diagram of an equivalent electrical circuit for the apparatus illustrated in FIG. 3;

FIG. 5 is a graph illustrating time response characteristics of a voltage in the equivalent circuit diagram of FIG. 4;

FIG. 6 is a graph illustrating a charging time versus an amount of charge of toner according to an exemplary embodiment of the present invention;

FIG. 7 is a graph illustrating the resistivity of a carrier versus a toner charging time according to an exemplary embodiment of the present invention;

FIG. 8 is a view of an apparatus measuring the resistance of a carrier according to an exemplary embodiment of the present invention;

FIG. 9A is a view illustrating an example of a development unit increasing a toner supply amount to a developing roller according to an exemplary embodiment of the present invention;

FIG. 9B is a view illustrating the intensity of magnetic force in a supply region of the development unit illustrated in FIG. 9A;

FIG. 9C is a view explaining an operation of the development unit illustrated in FIG. 9A;

FIG. 10A is a view illustrating another example of a development unit increasing a toner supply amount to a developing roller according to an exemplary embodiment of the present invention;

FIG. 10B is a view illustrating an operation of the development unit illustrated in FIG. 10A;

FIG. 11A is a view illustrating another example of a development unit increasing a toner supply amount to a developing roller according to an exemplary embodiment of the present invention;

FIG. 11B is a view illustrating an operation of the development unit illustrated in FIG. 11A;

FIG. 12 is a view of a single-pass type multi-color development unit according to an exemplary embodiment of the present invention;

FIG. 13 is a view illustrating the principle of a tri-level exposure method according to an exemplary embodiment of the present invention; and

FIG. 14 is a view of a multi-pass type multi-color development unit according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An exemplary embodiment of the present invention provides a hybrid type (or touchdown type) image forming apparatus capable of forming a magnetic brush consisting of a toner and a carrier on the surface of a magnetic roller. The hybrid type image forming apparatus supplies only the toner from the magnetic brush to a developing roller and moves the toner to a photosensitive body to develop an electrostatic latent image on the photosensitive body.

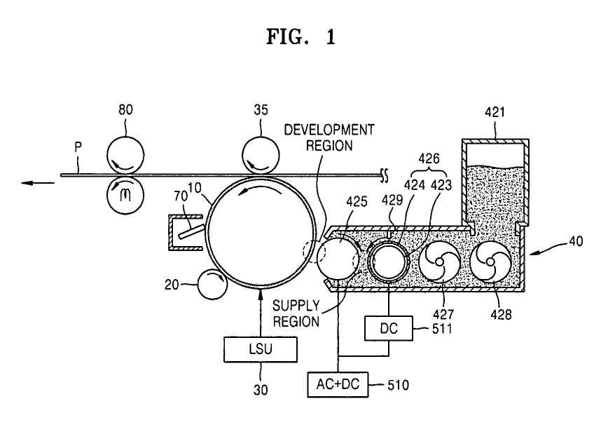

FIG. 1 is a view of a hybrid type image forming apparatus according to an exemplary embodiment of the present invention. Referring to FIG. 1, the apparatus includes a photosensitive body 10, a charger 20, an exposer 30, a development unit 40, a transfer unit 35, a fixer 80 and a cleaning member 70. The purpose of charger 20 and the exposer 30 is to form an electrostatic latent image on the photosensitive body 10. The charger 20 may be a corona discharger or a charging roller. The exposer 30 may a laser scanning unit (LSU) illuminating a laser beam onto the photosensitive body 10.

The development unit 40 includes a developing roller 425, a magnetic roller 426, agitation members 427 and 428, a developer regulating member 429 and a toner hopper 421 containing toner. The developing roller 425 is disposed in a configuration so that it does not contact the photosensitive body 10 and the magnetic roller 426. A composite power source 510 provides a development bias capable of moving the toner from the developing roller 425 to the photosensitive body 10. A DC power source 511 provides a supply bias capable of moving the toner from the magnetic roller 426 to the developing roller 425. According to a non-contact development method, a space (development gap) between the developing roller 425 and the photosensitive body 10 is about 150-400 μm and may be 200-300 μm. When the development gap is smaller than 150 μm, a background portion is contaminated. When the development gap is larger than 400 μm, it is difficult to move the toner to the photosensitive body 10, so that a sufficient image density is hard to achieve. The magnetic roller 426 includes a rotating sleeve 424 and a magnetic core 423 installed within the sleeve 424 to provide a magnetic force to form a magnetic brush. A space between the magnetic roller 426 and the developing roller 425 is about 0.3-0.7 mm. A toner layer formed on the developing roller 425 may be about 0.5-1.0 mg/cm². For that purpose, the space between the magnetic roller 426 and the developing roller 425 is about 0.2-0.5 mm. An average potential difference between the developing roller 425 and the magnetic roller 426 may be about 50-200V, an amount of charge of the toner may be 10-20 μC/g and a speed ratio of the magnetic roller 426 to the developing roller 425 may be about 0.5-2.0.

The development unit 40 contains a developer where the toner and the carrier are mixed. The toner and the carrier are agitated by rotation of the agitation members 427 and 428 and rub against each other. The toner is charged by this rubbing. Generally, it takes a certain amount of time before an amount of charge of the toner reaches a saturated value. When a new toner (not charged) is supplied from the toner hopper 421 to the development unit 40, the new toner is agitated by the agitation members 427 and 428 and reaches the magnetic roller 426. It is possible to finally form a toner layer charged to a saturated state on the developing roller 425. This may be done by optimizing the composition of a material of the toner or the carrier. Alternatively, a toner layer charged to a saturated state may be formed by controlling conditions such as the structure or the number of rotations of the agitation members 427 and 428 so that the toner may be sufficiently charged while the toner reaches the magnetic roller 426. The developer regulating member 429 regulates the magnetic brush formed at the magnetic roller 426 in a uniform manner. Only the toner is separated from the magnetic brush and moved to the developing roller 425 by the supply bias.

According to an exemplary implementation, the charger 20 charges the surface of the photosensitive body 10 at a uniform potential. The exposer 30 illuminates light that corresponds to image information onto the photosensitive body 10. Accordingly, an electrostatic latent image including an image portion and a non-image portion with different potentials is formed on the surface of the photosensitive body 10. In a supply region where the developing roller 425 and the magnetic roller 426 face each other, the toner is separated from the magnetic brush by the supply bias applied to the magnetic roller 426 and then supplied to the developing roller 425. A uniform toner layer is formed on the outer periphery of the developing roller 425. While the toner layer formed on the developing roller 425 passes through a development region where the photosensitive body 10 and the developing roller 425 face each other, the toner is separated from the toner layer on the developing roller 425 and attached on the image portion by the development bias. Accordingly, a visual toner image is formed on the photosensitive body 10. The toner image is transferred to a recording medium P by a transfer electric field provided from a transfer unit 35. A fusing unit 80 fuses the toner image onto the recording medium P using heat and pressure. The cleaning member 70 removes the remaining toner from the surface of the photosensitive body 10.

To solve the problem of a development ghost, many efforts have been made in the prior art to collect a residual toner on a developing roller and to remove an after-image of an image that has been previously developed from the developing roller after passing a development region. These efforts made in the prior art include a method for collecting toner on a developing roller using a magnetic roller for collection, a method for collecting toner from the developing roller to a magnetic roller by changing the direction of an electric field formed between the developing roller and the magnetic roller and a method for collecting toner on a developing roller using a magnetic brush by rotating the developing roller and a magnetic roller in the same direction (such as, a direction in which directions of the surfaces of the two rollers move opposite to each other in a region where the two rollers face each other).

However, the method that uses the magnetic roller for collection requires a large-sized development apparatus. Also, the method that changes the direction of the electric field between the developing roller and the magnetic roller is difficult to apply because it is difficult to make a bias providing an optimized development condition compatible with a bias providing an optimized collecting condition. The increase in the price of a power supply also makes it difficult to apply this method. Also, the carrier has a charged polarity opposite to that of the toner. The carrier, particularly, the carrier with a small diameter may be moved to the developing roller by a bias collecting the toner from the developing roller to the magnetic roller, and this carrier may be attached back on a background portion of the photosensitive body. Since the carrier has lower electrical resistance than that of the toner, the carrier may cause transfer defect and density non-uniformity of an image due to charge leakage when an image developed on the photosensitive body is transferred to paper or an intermediate transfer medium.

An exemplary embodiment of the present invention solves the above problem and prevents the development ghost by supplying a sufficient amount of toner onto the developing roller 425 and forming a uniform toner layer.

To form the uniform toner layer, a sufficient amount of toner should be supplied to the developing roller 425 from the magnetic brush within a time period shorter than a time period for which the magnetic brush passes through the supply region. For that purpose, the relationship between conductivity of a developer and a movement rate of the toner from the magnetic roller 426 to the developing roller 425 has been considered. Charged toner is moved from the magnetic brush to the developing roller 425 in the supply region. When the resistivity of the developer is less than 10⁹ Ωcm, the toner moves by an amount so that the potential of the toner layer formed on the surface of the developing roller 425 becomes a potential difference between the magnetic roller 426 and the developing roller 425. At this point, a time period before the toner moves is shorter than a time period in which the magnetic brush passes through the supply region, so that the toner moves very fast. Therefore, a sufficient amount of the toner is supplied to the development region, which effectively prevents the development ghost. Also, even the continuous printing of a high density image facilitates the prevention of a density non-uniformity of a printed image.

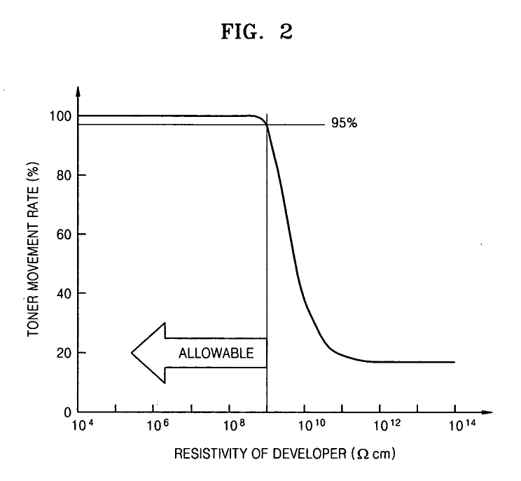

Assuming that movement direction of the surfaces of the developing roller 425 and the magnetic roller 426 are the same, the movement speed of the surfaces is 0.3 m/s, a space between the developing roller 425 and the magnetic roller 426 is 0.5 mm, a DC potential difference between the developing roller 425 and the magnetic roller 426 is 100V, and an amount of charge of the toner is 13 μC/g, the relationship between the resistivity of the developer and a movement rate of the toner from the magnetic roller 426 to the developing roller 425 has been examined. The result of the examination is illustrated in a graph of FIG. 2. A toner movement rate of 100% means that a toner movement rate is saturated. Referring to FIG. 2, a toner movement rate of 95% is used for a reference because a 5% difference of the toner movement rate cannot be recognized on a finally printed image.

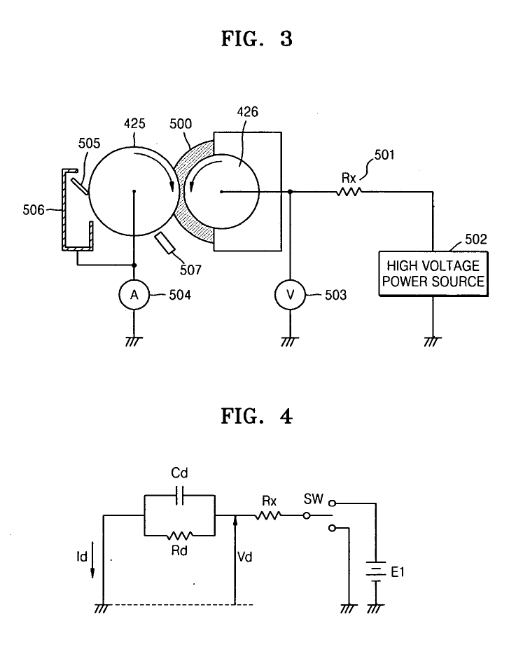

FIG. 3 is a view illustrating an example of an apparatus capable of measuring the resistance of a developer. Referring to FIG. 3, the apparatus includes a resistor 501 (whose value is Rx), a high voltage power source 502, a voltage meter 503, a current meter 504, a blade 505 removing the toner on the developing roller 425 and a case 506 receiving the removed toner. While a magnetic brush 500 formed on the magnetic roller 426 contacts the developing roller 425, the high voltage power source 502 applies a DC current between the developing roller 425 and the magnetic roller 426. For example, when negatively charged toner is used, the high voltage power source 502 applies a voltage of about −100V. The toner contained in the developer moves to the developing roller 425, and the toner layer is formed on the surface of the developing roller 425. The blade 505 removes the toner layer. When the movement of the toner and the removal of the toner layer are repeated, a current that corresponds to the quantity of electric charge of the toner moved to the developing roller 425 is measured by the current meter 504. A voltage applied between the developing roller 425 and the magnetic roller 426 is measured by the voltage meter 503. The resistance of the developer may be calculated from the measured voltage and current. The resistivity of the developer is obtained by multiplying the resistance of the developer by an area in which the developer (magnetic brush) on the magnetic roller 426 contacts the developing roller 425 (that is, product of a length where the developer is attached on the magnetic roller 426 and a nip width of the magnetic brush) and then dividing the product by a space between the magnetic roller 426 and the developing roller 425.

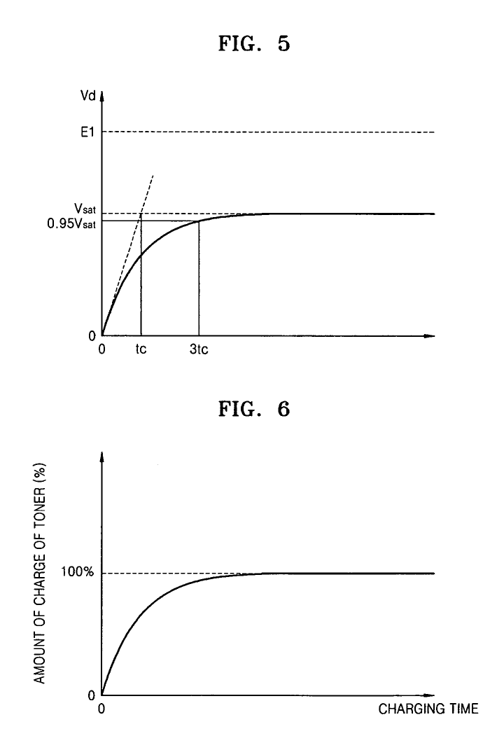

FIG. 4 is a diagram of an equivalent electrical circuit for the apparatus for measuring the resistance of the developer illustrated in FIG. 3. FIG. 5 is a graph illustrating time response characteristics of a voltage Vd in the equivalent circuit diagram of FIG. 4. A method for obtaining the resistivity of the developer and the reason the developer with low resistivity is valid will be described with reference to FIGS. 4 and 5.

The developer is expressed as a parallel circuit consisting of a capacitor Cd and a resistor Rd. When a voltage E1 is applied from the high voltage power source 502, a response waveform of the voltage Vd measured by the voltage meter 503 may be obtained. The resistance of the resistor Rd may be calculated from a saturated voltage Vsat of this response waveform, a voltage E1 and resistance Rx of a resistor 501 for measurement. Also, a time constant tc may be calculated from the initial slope of the response waveform. The above values may be calculated using the following equations 1.
Vd=E1×{Rd/(Rx+Rd)}×[1−exp{−t/(Rd×Cd)}]
Id=(E1−Vd)/Rx
Vsat=E1×Rd/(Rd+Rx)
Rd=Rx/(E1/Vsat−1)
Cd=tc/Rd Equations 1

The toner from the toner layer formed on the surface of the developing roller 425 is developed on the photosensitive body 10 in the development region. When the surface of the developing roller 425 reaches the supply region, the toner is moved from the magnetic brush to the developing roller 425, so that the toner layer is recovered to the original toner layer. This process is analogous to the response experienced when the voltage E1 is applied in the equivalent circuit of FIG. 4. According to the saturated voltage Vsat, the movement rate of the toner is saturated in a graph illustrated in FIG. 2. Referring to FIG. 5, a time period taken before a voltage reaches 95% of the saturated voltage Vsat is approximately three times the time constant tc. For example, the toner layer on the surface of the developing roller 425 is recovered to 95% of the original toner layer within a time period that is three times the time constant tc. When the toner layer is recovered up to 95%, the development ghost may be prevented. That is, a difference of an image density due to 5% of a recovery rate of the toner layer is not recognized from a finally printed image. Therefore, the resistance Rd of the developer is determined so that three times a time constant (tc) is shorter than the time taken until the surface of the developing roller 425 is separated after contacting the magnetic brush (that is, a time until the surface of the developing roller 425 passes through the supply region). Resistivity of the developer obtained on the basis of the above facts may be almost 10⁹ Ωcm.

It is possible to realize the resistivity of the developer less than 10⁹ Ωcm by controlling the composition of the carrier and the toner. The resistance of the developer changes depending on the electric resistance of the carrier, and the mobility and quantity of electric charge of the toner. To obtain a developer whose resistivity is 10⁹ Ωcm or less, processes of manufacturing the developer while changing the above-described parameters and measuring the resistance of the manufactured developer while changing the quantity of electric charge of toner to determine an appropriate combination are repeated. A parameter with a great influence on the resistance of the developer is the electric resistance of the carrier. The electric resistance of the carrier may be controlled by changing the resistance of a wick material of the carrier or an amount of doping of a conductive material on a surface coating material. The wick material of the carrier includes ferrite, magnetite and iron.

Next, initial charging of the toner is considered. When the toner in the development unit 40 is consumed and an amount of the toner is reduced, a new toner is supplied. Since the newly supplied toner has not been charged, the new toner should be quickly charged. When the charging of the new toner is delayed, a slightly charged toner is used to the developing process to cause contamination of a background portion and toner scattering. A method of using a carrier of low resistance is used in order to quickly charge the toner.

During a supply time for which the newly supplied toner reaches the developing roller 425, the toner should be charged by as much as a degree so that the background portion is not contaminated. For example, it is possible to set the supply time at 30 seconds on the assumption that a linear speed of the developing roller 425 is 0.3 m/s, and the length of the developing roller 425 is made to correspond to the vertical length of A4-sized paper in a developing device using the agitation members 427 and 428 illustrated in FIG. 1. In that case, a time (a reference charging time) consumed for properly charging the newly supplied toner may be within 30 seconds.

According to an exemplary implementation, a method for measuring a charging time will be described. A case of 100 cc is used as a developer case to mix the toner and the carrier. A 210HS-2A suction type charge measurement device by Trek Co. is used as a device to measure the quantity of electric charge. A ball-mill mixer is used as a mixer. For example, a case of mixing a carrier with a diameter of 50 μm and a toner with a diameter of 8 μm is described. First, a carrier of 50 g is uniformly put into a case laid to a side and a toner of 4 g is uniformly dispersed on the carrier. The rotation speed of the ball-mill mixer is controlled so that the case rotates thirty times per minute to agitate the carrier and the toner. When 10 seconds, 20 seconds, 30 seconds, 1 minute, and 2 minutes elapses, mixing is suspended and a developer is collected, so that the quantity of electric charge of the toner is measured using the suction type charge measurement device. A graph demonstrating a relationship between the charge of the toner and the charging time is illustrated in FIG. 6.

The amount of charge of toner required while the newly supplied toner reaches the developing roller 425 is determined with consideration of an influence of the amount of charge of the newly supplied toner on the amount of charge of the entire toner supplied to the developing roller 425. Actually, an amount of the toner moving from the magnetic brush of the magnetic roller 426 to the developing roller 425 is about 10% of the toner contained in the magnetic brush. Therefore, about 10% of the toner contained in the magnetic brush is constantly supplied to the magnetic brush. 5% of the entire toner included in the magnetic brush has a minimal influence on a finally printed image even when the 5% of the toner is weakly charged. Therefore, 10% of the toner constantly supplied to the magnetic brush may be agitated for half of a charging time required for the toner to reach a saturated charge. Then, it is expected that about half of the 10% of the toner is charged up to the saturated charge, and the other half of the 10% of the toner is charged up to half of the saturated charge. Therefore, a reference charging time may be set to half of a time taken until the 10% toner reaches the saturated charge. Since a quantity of toner charge due to agitation within the developing unit 40 for the same charging time may be different from a quantity of toner charge due to agitation in the above-described device measuring the quantity of electric charge, a reference charging time that can be applied to an actual development unit is determined using a repeated experiment.

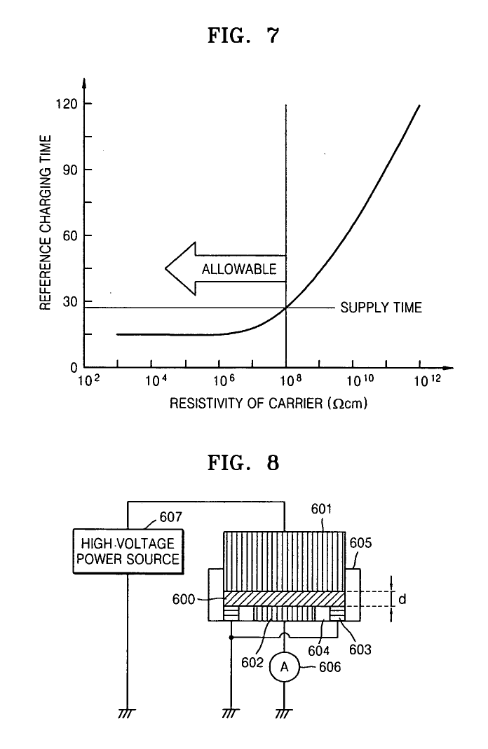

An examination of the relationship between the resistivity of the carrier and the reference charging time using several toners and carriers demonstrates that the reference charging time decreases when the resistance of the carrier is lowered. Generally, a graph illustrated in FIG. 7 is obtained. A conclusion that the resistivity of the carrier may be 108 Ωcm or less is obtained from the above experimental results. When the resistivity is no greater than 108 Ωcm, a proper reference charging time may not be achieved depending on the type of the carriers. The graph illustrated in FIG. 7 demonstrates a relationship between a reference charging time and carrier resistivity in a combination of a toner and a carrier where a reference charging time decreases as the resistivity of the carrier is lowered among available combinations of several toners and carriers. Therefore, the graph illustrated in FIG. 7 may be a useful guide in determining a proper combination of a carrier and a toner, capable of quickly charging a newly supplied toner to prevent contamination of a background portion and toner scattering.

A method for measuring the resistivity of a carrier will be described with reference to FIG. 8. A carrier 600 is positioned between electrodes 601 and 602 for measurement, and a high voltage is applied to the electrodes 601 and 602 using a high voltage power source 607. A current flowing through the electrode 602 is measured using a current meter 606. Resistance is calculated based on the relationship between a voltage and a current. According to an exemplary implementation, an insulator 604 and a guide electrode 603 are installed around the electrode 602 for measurement. Any influence of current flowing through an inner wall of a case 605 receiving the carrier is removed using the above structure, so that correct resistance may be obtained. The resistivity of the carrier is calculated by multiplying the obtained resistance by the area of the electrode 602 for measurement and dividing the obtained value by the thickness d of the carrier. Force applied by the electrode 601 to the carrier is 0.1 kg/cm². The voltage applied and the thickness d of the carrier are controlled such that the intensity of an electric field applied to the carrier is 10³ KV/m.

To increase a movement rate of the toner from the magnetic roller 426 to the developing roller 425, a supply bias where a DC current and an AC current are mixed is applied between the magnetic roller 426 and the developing roller 425. This allows an electric field between the magnetic roller 426 and the developing roller 425 to change with respect to time. An electric field that changes with respect to time includes an alternating electric field and a pulsating electric field. The alternating field is an electric field whose direction and intensity all change with respect to time. For example, when a DC potential difference between the magnetic roller 426 and the developing roller 425 is 100V, a peak-to-peak voltage of an AC voltage may be selected to be 300V. Then, a potential difference between the magnetic roller 426 and the developing roller 425 becomes −50˜250V. Therefore, the electric field between the magnetic roller 426 and the developing roller 425 becomes the alternating electric field whose direction and intensity change with respect to time. Since the developer used in an exemplary embodiment of the present invention has a very small resistivity that is no greater than 10⁹ Ωcm, a potential difference between the magnetic roller 426 and the developing roller 425 instantly increases when an AC voltage with a large amplitude is applied. This facilitates an excessive current that flows between the magnetic roller 426 and the developing roller 425. Such an excessive current may cause disorder to a power supply. Therefore, an AC voltage is required to be set so that an excessive current does not flow. This condition is met by setting the amplitude of the AC voltage so that the electric field between the magnetic roller 426 and the developing roller 425 is a pulsating electric field whose direction does not change and whose intensity changes. For example, when a DC potential difference between the magnetic roller 426 and the developing roller 425 is 100V, a peak-to-peak voltage of an AC voltage may be selected to be 180V. Then, a potential difference between the magnetic roller 426 and the developing roller 425 becomes 10˜190V. Therefore, the electric field between the magnetic roller 426 and the developing roller 425 becomes the pulsating electric field whose direction does not change and whose intensity changes with respect to time. It is possible to improve a movement rate of the toner to the developing roller 425 using the pulsating electric field.

Another method for increasing a toner supply amount from the magnetic roller 426 to the developing roller 425 will be considered below.

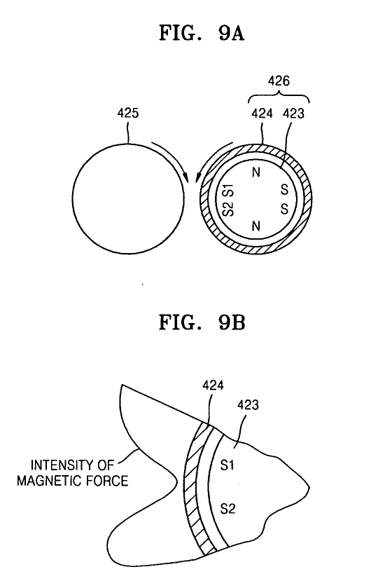

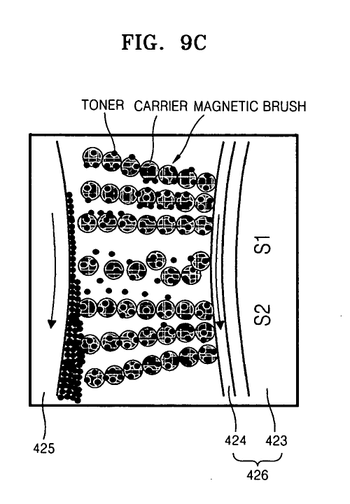

Referring to FIG. 9A, a magnetic core 423 generating a magnetic brush inside a sleeve 424 is fixedly disposed. The magnetic core 423 is polarized into a plurality of poles. A pair of magnetic poles S1 and S2 have the same polarity and are disposed in a region facing a supply region. The intensity of magnetic force drastically decreases between the magnetic poles S1 and S2 as illustrated in FIG. 9B. A magnetic brush generated by the magnetic pole S1 drastically collapses as illustrated in FIG. 9C when reaching a portion located between the magnetic poles S1 and S2 as the sleeve 424 rotates. The magnetic brush is then re-generated once the magnetic pole S2 is reached. At this point, the magnetic brush that has collapsed between the portion located between the magnetic poles S1 and S2 moves toward the magnetic pole S2 at a very fast speed. The speed at which the magnetic brush moves drastically decreases when the magnetic brush is re-generated by the magnetic pole S2. By this impulse, the toner attached on the carrier is separated form the carrier and moved to the developing roller 425 by a supply bias. According to the above construction, since the toner in the supply region is separated from the carrier by electric force formed by the supply bias and the mechanical impulse generated during the collapse and regeneration of the magnetic brush, it is possible to separate a very large amount of toner from the magnetic brush and to move the separated toner to the developing roller 425. Therefore, a sufficient amount of toner which is greater than an amount of toner consumed in the development region where the photosensitive body 10 and the developing roller 425 face each other, may be supplied to the developing roller 425 again, so that the development ghost may be prevented.

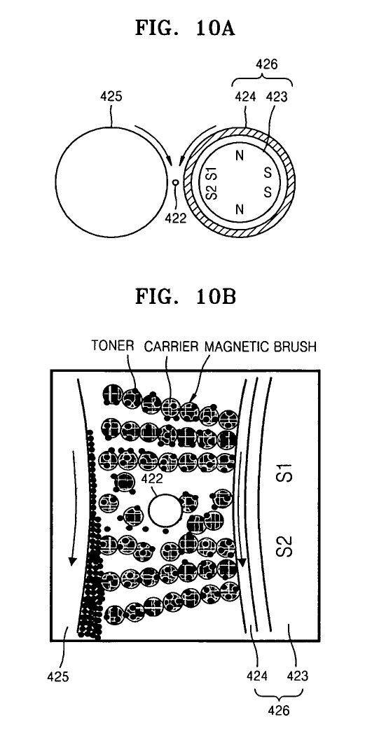

Referring to FIG. 10A, a wire 422 (collision member) may be installed between the developing roller 425 and the magnetic roller 426. Referring to FIG. 10B, since the magnetic brush that has collapsed between the magnetic poles S1 and S2 collides with the wire 422, the toner may be more easily separated from the carrier. The wire 422 may be made of metal with high tension such as tungsten and stainless steel. The diameter of the wire may be 0.05-0.20 mm and appropriately selected with consideration of a space between the developing roller 425 and the magnetic roller 426. For example, when the space between the developing roller 425 and the magnetic roller 426 is 0.3 mm, the wire with a diameter 0.05 mm is selected. Since the toner is easily separated from the magnetic brush, the development ghost and the non-uniform density of an image are effectively prevented when a large amount of toner is required to be supplied to the developing roller 425, for example, when high speed printing is required or high density printing is required. The collision member is not limited to the wire 422 but any member including a mesh-shaped member may be used as long as the member is installed between the developing roller 425 and the magnetic roller 426 to collide with the magnetic brush.

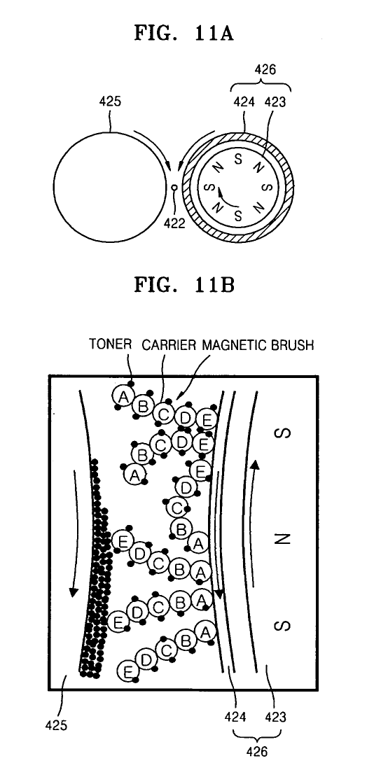

Referring to FIG. 11A, the magnetic core 423 installed inside the sleeve 424 is rotated. The magnetic core 423 is polarized such that N poles and S poles are alternatively located in turns with respect to each other. Referring to FIG. 11B, the sleeve 424 rotates counterclockwise and the magnetic core 423 rotates clockwise. The carriers are attached on the surface of the sleeve 424 in the order of E-D-C-B-A in the upstream of the supply region. Since the magnetic core 423 rotates, the direction of magnetic force changes in the supply region. The carriers are attached on the surface of the sleeve 424 in the order of A-B-C-D-E in the downstream of the supply region. When the direction of the magnetic force is changed in the supply region by rotating the magnetic core 423, the magnetic brush is turned over as illustrated by an arrow of FIG. 11B. This allows all of the toner constituting the magnetic brush to approach the developing roller 425 and an amount of the toner moving to the developing roller 425 to increase. Therefore, a sufficient amount of toner is supplied to the developing roller 425 and a uniform toner layer may be formed.

In addition to an exemplary embodiment of the present invention arranging the poles of the magnetic core 423 and rotating the magnetic core 423, the resistivity of the developer and the resistivity of the carrier may be controlled as described above. Also, a bias generating the pulsating electric field as described above may be applied as a supply bias between the developing roller 425 and the magnetic roller 426.

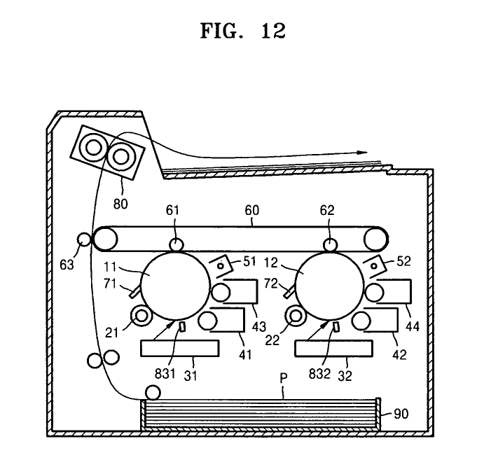

The above development unit may be applied to a color development unit. FIG. 12 is a view of a single-pass type multi-color development unit according to an exemplary embodiment of the present invention. The multi-color development unit according to an exemplary embodiment of the present invention includes two image forming units using a tri-level exposure method. One image forming unit includes a photosensitive body 11, a charging roller 21, an exposer 31, development units 41 and 43, a pre-transfer charger 51 and a cleaner 71. The other image forming unit includes a photosensitive body 12, a charging roller 22, an exposer 32, development units 42 and 44, a pre-transfer charger 52 and a cleaner 72. The development unit illustrated in FIGS. 1, 9A, 10A, and 11A may be used for the development units 41, 42, 43, and 44.

The tri-level exposure method is a method of forming three potential portions consisting of a high potential portion VH, a middle potential portion VM, and a low potential portion VL on each of the photosensitive bodies 11 and 12. The tri-level exposure method uses one type of exposure by controlling an exposure power of the exposers 31 and 32 in three steps consisting of off, a middle power, and a full power when illuminating light on the photosensitive bodies 11 and 12 using the exposers 31 and 32. Toners charged at different polarities are developed on the high potential portion VH and the low potential portion VL, respectively.

First, the image forming unit including the photosensitive body 11, the charging roller 21, the exposer 31, the development units 41 and 43, the pre-transfer charger 51, and the cleaner 71 will be described. The surface of the photosensitive body 11 is charged using the charger 21. For example, when negatively charging the photosensitive body 11, the charging is performed such that the high potential portion VH has a potential of −900V.

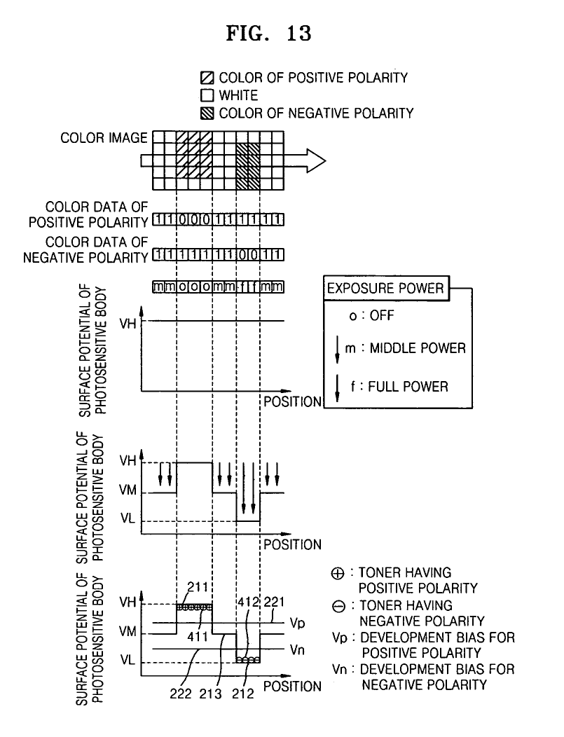

Next, the photosensitive body 11 is exposed by changing the exposure power in three steps depending on a color to be printed using the exposer 31. Referring to FIG. 13, when the photosensitive body 11 is negatively charged, positively charged toner is developed on the high potential portion VH. When an image signal is a signal to print a color of a positive polarity (that is, positive polarity color data is “0”), the exposure power is off and a corresponding portion on the photosensitive body 11 becomes the high potential portion VH. Negatively charged toner is developed on the low potential portion VL. When an image signal is a signal printing a color of a negative polarity (that is, negative polarity color data is “0”), the exposure power becomes the full power and a corresponding portion on the photosensitive body 11 becomes the low potential portion VL (for example, −30V). When an image signal is a white image, the exposure power becomes the middle power and a corresponding portion on the photosensitive body 11 becomes the middle potential portion VM (for example, −450V) between the high potential portion VH and the low potential portion VL.

Negatively charged toner 412 is then developed using the development unit 41. In that case, a development bias with a potential 222 located between a potential 212 of the low potential portion VL and a potential 213 of the middle potential portion VM is applied to the development unit 41. The negatively charged toner 412 is developed on the low potential portion VL. Positively charged toner 411 is developed using the development unit 43. A development bias with a potential 221 located between a potential 211 of the high potential portion VH and a potential 213 of the middle potential portion VM is applied to the development unit 43. The positively charged toner 411 is developed on the high potential portion VH.

Next, the positively charged toner 411 and the negatively charged toner 412 developed on the photosensitive body 11 are changed to one polarity using the pre-transfer charger 51. For example, it is possible to change the polarity of the negatively charged toner 412 to a positive polarity by illuminating a positive corona using the pre-transfer charger 51. A dual-colored toner image formed on the photosensitive body 11 is transferred to an intermediate transfer belt 60 by a negative voltage applied to a first transfer roller 61.

The above-described same process is performed on the other image forming unit including the photosensitive body 12, the charging roller 22, the exposer 32, the development units 42 and 44, the pre-transfer charger 52, and the cleaner 72. A dual-colored toner image formed on the photosensitive body 12 is transferred to the intermediate transfer belt 60 by a negative voltage applied to a first transfer roller 62.

Accordingly, four-colored toner image is formed on the intermediate transfer belt 60. This four-colored toner image is transferred to paper P supplied from a cassette 90 through a second transfer roller 63, and then fused on the paper P using a fusing unit 80, so that a four-colored image may be printed. When the four colors are cyan, magenta, yellow, and black, respectively, a full color image may be obtained. Toner remaining on the photosensitive bodies 11 and 12 is removed by the cleaning members 71 and 72. The tri-level method of dividing the potential of the photosensitive body into three potentials has approximately half of a potential range required for developing one color compared to a method with two divisions (dividing into an image portion and a non-image portion), which is used for most laser printers. Also, the charging characteristics of the photosensitive body changes depending on environment conditions (for example, temperature and humidity), or deterioration caused by constant use. Therefore, even when the photosensitive body is exposed using the same exposure power, the surface potential of the photosensitive body changes. When the potential of the high potential portion VH or the low potential portion VL changes, an amount of toner developed changes, which changes printing density. When the potential of the middle potential portion VM changes, the toner is developed on a background. This results in the contamination of the background because the toner should not be developed on the background. Particularly, since the change of the middle potential portion VM is large, it is required to stably control the potential in order to use the tri-level method.

Therefore, an electrophotographic apparatus using the tri-level method adapts a method of detecting a surface potential after exposure using surface potential sensors 831 and 832 and controlling the chargers 21 and 22 or the exposers 31 and 32 to stably control the potential. It is possible to print a dual-colored image by exposing the photosensitive body one time using the above-described method. Therefore, since a dual-color printing may be performed using one exposure, miniaturization of a product and cost reduction may result from using this method.

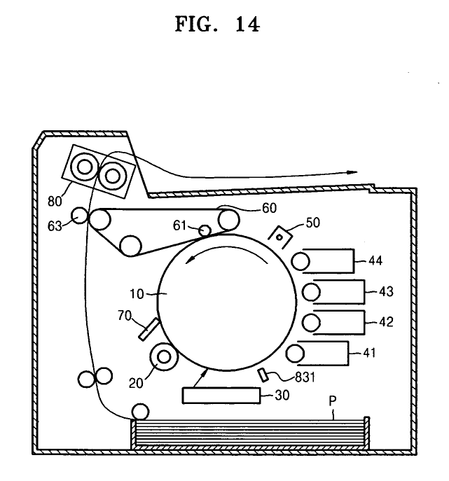

FIG. 14 is a view of a multi-pass type multi-color development unit using a tri-level method according to an exemplary embodiment of the present invention. The development unit includes a photosensitive body 10, four development units 41, 42, 43, and 44 arranged around the photosensitive body 10, and an intermediate transfer belt 60. First, an initial dual-colored toner image is developed on a photosensitive body 10 using development units 41 and 42. The polarity of the developed dual-color toner image is changed to an appropriate polarity by using a pre-transfer charger 50 and is then transferred to an intermediate transfer belt 60. Next, another dual-colored toner image is developed on the photosensitive body 10 using development units 43 and 44 and transferred to the intermediate transfer belt 60 using the same method. Accordingly, a four-colored toner image is formed on the intermediate transfer belt 60. The four-colored toner image is transferred onto paper P by using a second transfer roller 63 and fused by using a fusing unit 80, so that a four-colored image may be printed. When the four colors are cyan, magenta, yellow, and black, respectively, a full color image may be obtained.

The contamination of the background is particularly problematic in a multi-color image forming apparatus using a tri-level exposure method. However, the image forming apparatus of an exemplary embodiment of the present invention may obtain high quality printing image with almost no background contamination. Since a bias collecting the toner from the developing roller to the magnetic roller is not used, the carrier with a small diameter is not attached to the background of the photosensitive body via the developing roller. Therefore, it is possible to solve a transfer defect or density non-uniformity of an image caused by charge leakage when transferring an image developed on the photosensitive body to paper or an intermediate transfer medium using the carrier with low electric resistance.

Though not shown in the drawings, it is obvious to those skilled in the art that a single-pass type image forming apparatus including four photosensitive bodies, four exposers forming a dual-level electrostatic latent image consisting of a non-image portion and an image portion on the four photosensitive bodies, respectively, four development units supplying toners of different colors to the electrostatic latent image formed on the respective photosensitive bodies to develop the same may be realized. A multi-pass type image forming apparatus including one photosensitive body, one exposer and four development units may be realized. More specifically, the exposer sequentially forms dual-level electrostatic latent images consisting of a non-image portion and an image portion that correspond to image information of respective colors. The four development units sequentially supply toner of different colors to the electrostatic latent images formed on the photosensitive body to develop the same.

As described above, according to the hybrid type image forming apparatus of an exemplary embodiment of the present invention, it is possible to realize a small image forming apparatus that provides an image having excellent image quality without the development ghost, and background contamination. Also, it is possible to realize a color image forming apparatus using a tri-level exposure method, capable of stable printing quality.

While the present invention has been shown and described with reference to certain exemplary embodiments thereof, it will be understood by those of ordinary skill in the art that various changes in form and details may be made therein without departing from the spirit and scope of the present invention as defined by the appended claims and their equivalents.

What is claimed is:

1. A hybrid type image forming apparatus using a developer that contains a mixture of a toner and a carrier, the apparatus comprising:
a photosensitive body on which an electrostatic latent image is formed;
a development unit comprising a developer, and a magnetic roller that is configured to form a magnetic brush containing a toner and a carrier on an outer periphery of the magnetic roller; and
a developing roller installed such that the developing roller does not contact the magnetic roller and the photosensitive body, and configured to develop the electrostatic latent image using the toner supplied from the magnetic brush, wherein the resistivity of the developer is no greater than 10⁹ Ωcm.

2. The apparatus of claim 1, wherein a bias generating a pulsating electric field is applied between the magnetic roller and the developing roller.

3. The apparatus of claim 1, wherein the resistivity of the carrier is no greater than 10⁸ Ωcm.

4. The apparatus of claim 1, wherein the magnetic roller comprises a rotating sleeve, and a magnetic core comprising a plurality of magnetic poles forming the magnetic brush and arranged inside the sleeve, and the plurality of magnetic poles comprise a pair of magnetic poles comprising the same polarity and facing a supply region where the magnetic roller faces the developing roller.

5. The apparatus of claim 4, wherein movement directions of the surfaces of the sleeve and the developing roller are the same in the supply region.

6. The apparatus of claim 5, wherein the developing unit further comprises a collision member installed in the supply region and colliding with the magnetic brush.

7. The apparatus of claim 5, wherein a bias generating a pulsating electric field is applied between the magnetic roller and the developing roller.

8. The apparatus of claim 1, wherein the magnetic roller comprises a rotating sleeve, and a magnetic core comprising a plurality of magnetic poles forming the magnetic brush and arranged inside the sleeve to rotate.

9. The apparatus of claim 8, wherein the magnetic core rotates in a direction opposite to a rotational direction of the sleeve.

10. The apparatus of claim 9, wherein movement directions of the surfaces of the sleeve and the developing roller are the same in a supply region where the developing roller faces the magnetic roller.

11. The apparatus of claim 10, wherein a bias generating a pulsating electric field is applied between the magnetic roller and the developing roller.

12. The apparatus of claim 1, further comprising:
a charger for charging the photosensitive body;
an exposer for scanning light on the photosensitive body; and
a plurality of development units for containing toners of different colors, thereby printing a color image.

13. The apparatus of claim 1, further comprising:
a first image forming unit comprising the photosensitive body, a charger for charging the photosensitive body, an exposer for exposing the photosensitive body in a tri-level exposure method, and two developing parts for containing toner of a first color and toner of a second color, respectively;
a second image forming unit comprising the photosensitive body, a charger for charging the photosensitive body, an exposer for exposing the photosensitive body in a tri-level exposure method, and two developing parts for containing toner of a third color and toner of a fourth color, respectively; and
an intermediate transfer body for transferring a toner image from the first and second image forming units, thereby printing a color image in a single-pass type.

14. The apparatus of claim 1, further comprising:
a charger for charging the photosensitive body;
an exposer for exposing the photosensitive body in a tri-level type; and
four development units for containing toner of a first color, a second color, a third color, and a fourth color, respectively, thereby printing a color image using a 2-pass method.

15. A hybrid type image forming apparatus using a developer that contains a mixture of a toner and a carrier, the apparatus comprising:
a photosensitive body on which an electrostatic latent image is formed;
a magnetic roller for forming a magnetic brush comprising a toner and a carrier on an outer periphery of the magnetic roller; and
a developing roller installed such that the developing roller does not contact the magnetic roller and the photosensitive body, and configured to develop the electrostatic latent image using the toner supplied from the magnetic brush,
wherein the magnetic roller comprises a rotating sleeve, and a magnetic core comprising a plurality of magnetic poles forming the magnetic brush and arranged inside the sleeve, and the plurality of magnetic poles comprise a pair of magnetic poles comprising the same polarity and facing a supply region where the magnetic roller faces the developing roller.

16. The apparatus of claim 15, wherein movement directions of the surfaces of the sleeve and the developing roller are the same in the supply region.

17. The apparatus of claim 16, further comprising a wire installed in the supply region and colliding with the magnetic brush.

18. The apparatus of claim 17, wherein a resistivity of the carrier is no greater than 10⁸ Ωcm.

19. The apparatus of claim 18, wherein a bias generating a pulsating electric field is applied between the magnetic roller and the developing roller.
